(19) United States
(12) Patent Application Publication
(10) Pub. No.: US 2004/0227679 A1
(43) Pub. Date: Nov. 18, 2004

(54) Electronic instrument with an invisible antena

(76) Inventor: Kuo-Ping Lu, Taipei Hsien (TW)

Correspondence Address: BIRCH STEWART KOLASCH & BIRCH, PO BOX 747, FALLS CHURCH, VA, 22040-0747, US

(21) Appl. No.: 10/841,517

(22) Filed: May 10, 2004

(30) Foreign Application Priority Data
May 16, 2003 (TW) 92208985

(51) Int. Cl. H01Q 1/24

(52) U.S. Cl. 343/702

(57) ABSTRACT

A mobile phone includes an antenna of relatively small thickness, and a shelter member of non-metal material mounted in such a manner to conceal the antenna underneath. A logo is provided on an outer face of the shelter member to provide an aesthetic appearance of the mobile phone.

### FIELD OF THE INVENTION

The invention relates to an electronic instrument, more particularly to an electronic instrument such as a mobile phone, which includes a shielding member that covers an antenna of the mobile phone and that is provided with a logo on an outer face thereof.

### BACKGROUND OF THE INVENTION

As the production technology advances ceaselessly, the electronic instrument of a latest production is designed in such a manner to facilitate operation and carrying along with the user. In order to catch up with the modern life and society of the present generation, more and more electronic instruments are constructed in compact size with fast performance capability. The rapid development in the telecommunication field, especially in the integrated printed circuit and chips, enables each person to possess a mobile phone. Rapid and easy exchange of information provided by the mobile phone brings lots of convenience to the user. Thus, the mobile phone becomes the most popular electronic device that is appreciated by the public.

For those businessmen, who have to travel a lot due to requirement, the mobile phone is the first communicating tool that he can lay his hand on if he or she is to contact with the outside world so that undesired delay can be avoided. Increase in the memory capacity of the mobile phone enables the same to store a lot of client's addresses and phone numbers, in addition to the important schemes and the intended schedules. Mobile phone of recent production permits the user to send and receive e-mail via, besides the conventional communication ways. High efficiency of the central processing unit in the mobile phone enables the user to take pictures, play music or to connect with the network.

A conventional mobile phone includes an elongated outer casing that encloses inner components therein and that is not easy to carry along within the palm of the user, and an antenna projecting outwardly from the outer casing. Since most of the users are in the habit of carrying the mobile phone in user's pockets such that the antenna tangles up with the user's pocket whenever he fetches the mobile phone from the pocket. In order to solve the aforesaid problem and to enhance the outward appearances thereof, the antenna can be a patch type and is confined within the outer casing of the mobile phone so as not to be visible, and includes a printed circuit board. Under this condition, no antenna is visible in the mobile phone of the newest production.

Referring to FIG. 1A, a front view of a conventional mobile phone 10 is shown to include a first half 10a and a second half 10a. The first half 10a includes a receiver 12 at an upper portion thereof for receiving an incoming call, and a display 14 at the central portion to show operation modes, incoming message or transmitting message. At the lower portion of the first half 10a, a plurality of operating buttons 16 are provided to facilitate dialing or transmitting information to a second party.

The first and second halves 10a,10a of the conventional mobile phone 10 are generally made from metal material or are electroplated. Since metal can interfere with sending and receiving signals of the antenna mounted within the first and second halves 10a,10a, an opening is formed through one of the first and second halves 10a,10a. A non-conductive material can be provided in the opening so as to retain the antenna free from being disturbed by the electromagnetic fields.

FIG. 1B shows a rear view of the conventional mobile phone 10, and includes a lid member 18 mounted on a lower portion of the second half 10b. The lid member 18 can be removed from the second half 10a when it is desired to replace a SIM card or a battery. A logo or label can be mounted on either one of the first and second halves 10a,10a. A non-metal casing 22 is provided on an upper portion of the second half 10a to retain an antenna of the conventional mobile phone 10 such that the incoming and outgoing signals are not hindered. However, the difference in colors of the non-metal casing 22 and the metal casing 10 adversely affect the entire appearance of the conventional mobile phone 10.

In addition to the mobile phone, the 3C instruments (computer, communication and consumer electronic device) are provided with wireless communication functions such that the arrangement of the antenna in the aforesaid manner interfere the transmitting and receiving signals.

### SUMMARY OF THE INVENTION

The object of the present invention is to provide an electronic instrument of 3C that includes an outer metal casing with an invisible antenna capable of transmitting and receiving telecommunicating signals without being interfered by electromagnetic field effect caused during operation of the mobile phone.

According to the present invention, an electronic instrument is provided to include: an outer metal casing; a mother board disposed within the outer metal casing; a coupling wire; an antenna disposed on the outer metal casing and electrically connected to the mother board by the coupling wire; and a shelter member disposed on the outer metal casing in such a manner to conceal the antenna thereunder.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective top view of a conventional mobile phone;

FIG. 1 is a perspective bottom view of the conventional mobile phone;

FIG. 2 is an exploded perspective view of the preferred embodiment of a mobile phone in accordance with the present invention;

FIG. 3A is a top planar view of the preferred embodiment of the mobile phone in accordance with the present invention;

FIG. 3B is a sectional view of the preferred embodiment taken along lines B-B′ of FIG. 3A; and

FIG. 3C is a sectional view of a modified preferred embodiment of the mobile phone in accordance with the present invention.

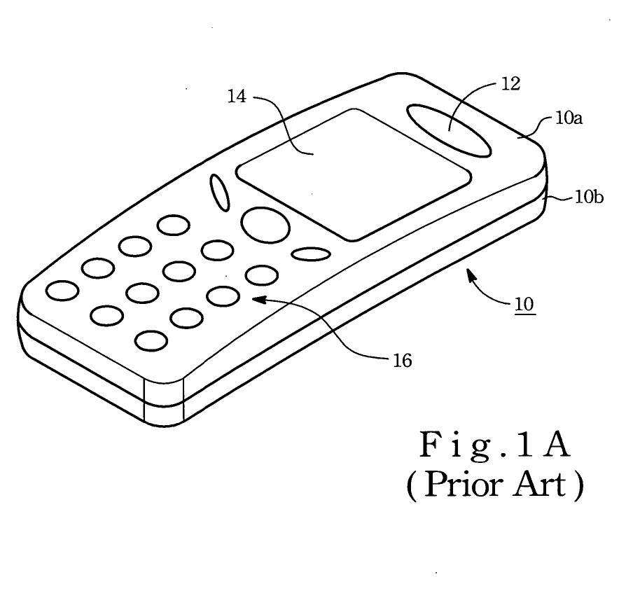

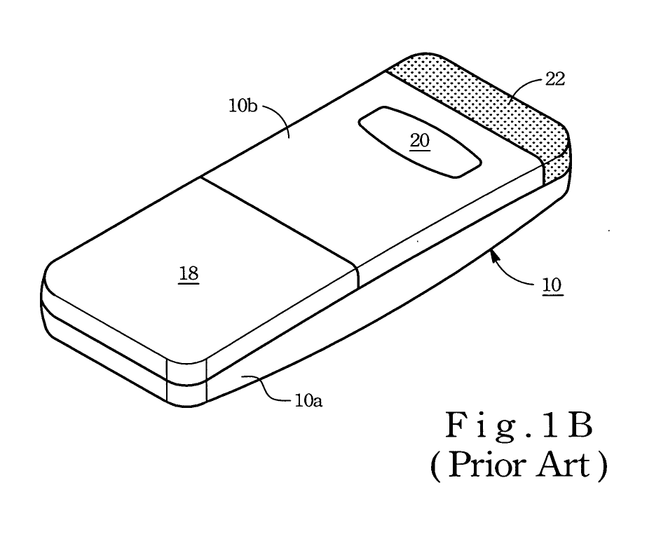

### DETAILED DESCRIPTION OF THE PREFERRED EMBODIMENTS

Before the present invention is described in greater detail with reference to the following preferred embodiments, it should be noted that same reference numerals have been used to denote similar elements throughout the specification.

Referring to FIG. 2, the preferred embodiment of an electronic instrument of 3C (computer, communication and consumer electronic device like a mobile phone) is shown to include an outer metal casing 32, a mother board 34, an antenna 36, a co-axial coupling wire 38, a shelter member 39.

As illustrated, the outer casing 32 includes a first half 32a, and a second half 32b coupled to the first half 32a so as to confine a plurality of electronic parts therein. Since the structure of these electronic parts is not the relevant feature of the present invention, a detailed description thereof is omitted herein for the sake of brevity.

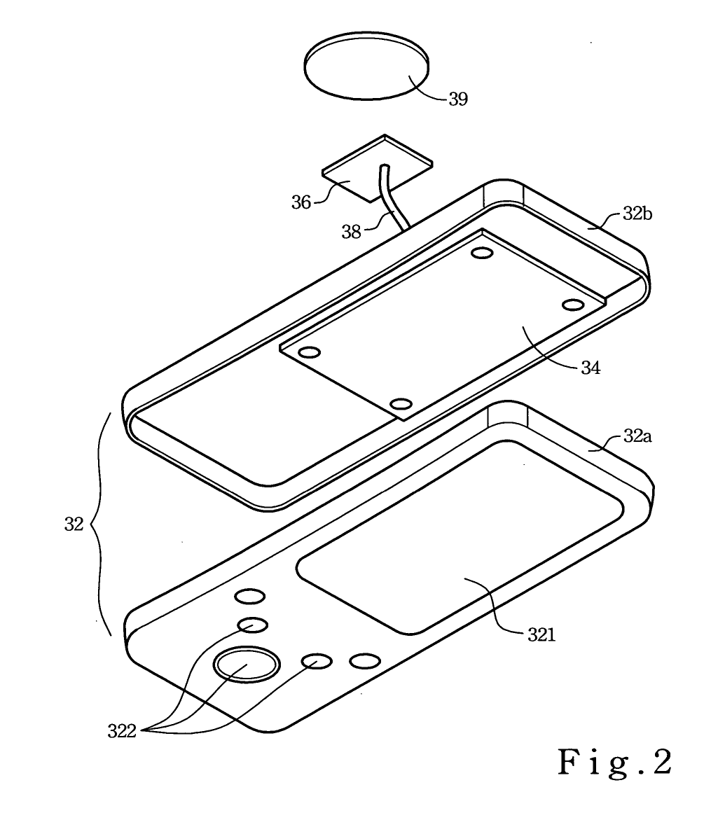

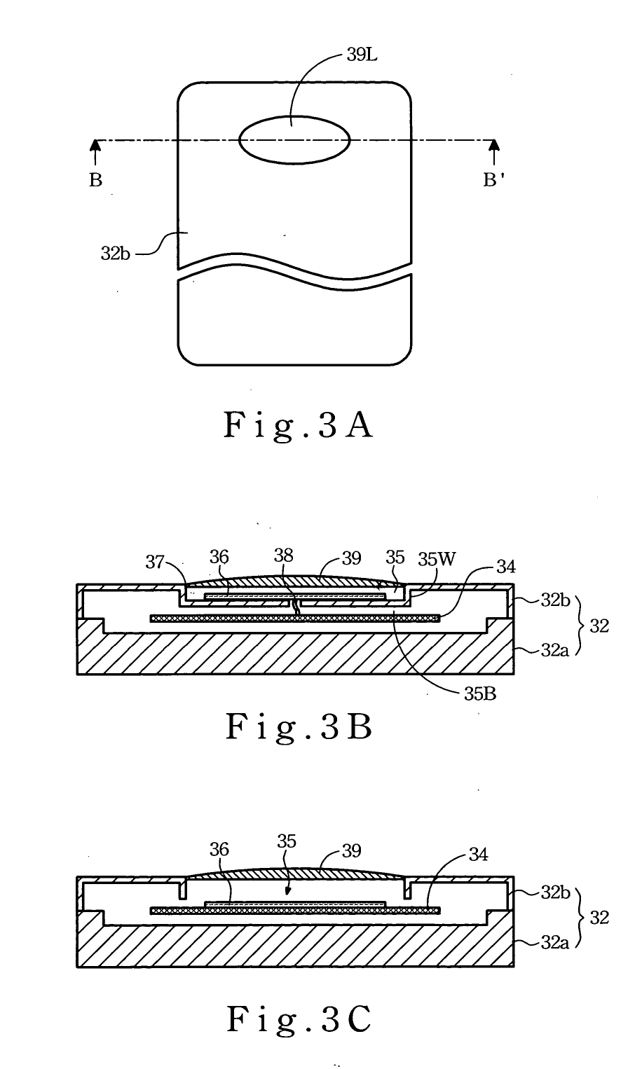

The mother board 34 is confined between the first and second halves 32a,32b. The first half 32a is formed with an elongated opening to receive a LCD (liquid crystal display) 321 that is electrically connected to the mother board 34. A plurality of operating switches 322 are provided on the first half 32a at a lower portion of the LCD, and are electrically connected to the mother board 34. The outer casing 32 is made from metal or can be made from other material, such as plastic. In case the outer casing 32 is made from plastic, an electroplated layer should be formed thereon so as to protect the electronic parts from being interfered by external electromagnetic disturbance. The mother board 34 is mounted to on an inner surface of the second half 32b by fastener screws. The second half 32b is formed with a recess 35 (see FIG. 3B) that extends inwardly from an outer surface thereof and that defines an opening 37 (see FIG. 3B) for access thereinto.

The recess 35 is defined by a recess-confining wall 35W that includes a bottom wall portion 35B formed with a through hole and a peripheral wall portion extending from the bottom wall portion 35B toward the outer surface of the second half 32b. The bottom wall portion 35B of the recess 35 has a depth ranging from 2 mm to 4 mm. The antenna 36 has a plate configuration, and preferably includes a printed circuit board or a flexible printed circuit. Alternatively, a patch antenna or a ceramic antenna can be used. Thus, the antenna 35 has a relatively small thickness, and is disposed on the bottom portion 35B of the recess 35. The coupling wire 38 extends through the through hole in the bottom wall portion 35B of the recess 35 to electrically interconnect the antenna 36 and the mother board 34 (see FIG. 3B). The shelter member 39 is disposed on the second half 32b of the outer casing 32 in such a manner to cover the opening 37 of the recess 35, thereby concealing the antenna 36 underneath. The shelter member 39 is preferably made from non-conductive material, such as plastic or paper, so as not to interfere with the transmitting and receiving message of the mobile phone via the antenna 36. A logo 39L or a label is attached on an outer face of the shelter member 39 so as to provide an aesthetic appearance of the mobile phone.

Since the antenna 36 is not exposed from the metal casing 32 of the mobile phone, an accidental collision thereto can be avoided, which, in turn, prolongs the service life of the mobile phone. In addition, the antenna 36 is mounted within one of the first and second halves 32a,32b, there is no need of providing a specific mold for producing an extra casing to retain the antenna 36, which, in turn, results in reduction in the manufacture cost of the mobile phone of the present invention.

Referring to FIG. 3C, a modified preferred embodiment of the mobile phone according to the present invention is shown to have a construction similar to the previous embodiment. Except that the recess 35 is in the form of a through hole. Thus, the antenna 36 is disposed above and electrically connected to the mother board 34.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An electronic instrument comprising:
an outer metal casing;
a mother board disposed within said outer metal casing;
a coupling wire;
an antenna disposed on said outer metal casing and electrically connected to said mother board by said coupling wire; and
a shelter member disposed on said outer metal casing in such a manner to conceal said antenna thereunder.

2. The electronic instrument according to claim 1, wherein said shelter member is made from non-metal materials, which include plastic or paper.

3. The electronic instrument according to claim 1, wherein said shelter member is provided with a logo or a label.

4. The electronic instrument according to claim 1, wherein said antenna has a plate configuration, and includes a printed circuit board.

5. The electronic instrument according to claim 1, wherein said antenna has a plate configuration, and is a patch antenna.

6. The electronic instrument according to claim 1, wherein said antenna has a plate configuration, and includes a FPC (flexible printed circuit) or a ceramic antenna.

7. The electronic instrument according to claim 1, wherein said outer metal casing has an outer surface, and a recess that extends inwardly from said outer surface, said antenna being disposed in said recess.

8. The electronic instrument according to claim 7, wherein said recess in said outer metal casing is defined by a recess-confining wall that has a bottom wall portion formed with a through hole, said coupling wire extending through said through hole in said bottom wall portion and electrically interconnecting said mother board and said antenna.

9. The electronic instrument according to claim 8, wherein said bottom wall portion of said recess has a depth ranging from 2 mm to 4 mm measured with respect to the outer surface of said outer metal casing.

10. An electronic instrument comprising:
a casing enclosing a plurality of electronic parts of said instrument, and having an outer surface and a recess that extends inwardly from said outer surface, said recess being defined by a recess-confining wall that has a bottom wall portion formed with a through hole;
a mother board disposed within said casing below said recess;
an antenna disposed within said recess in said casing;
a co-axial coupling wire extending through said through hole in said recess for interconnecting said mother board and said antenna; and
a shelter member disposed on said casing in such a manner to cover said recess and said antenna thereunder.

11. The electronic instrument according to claim 10, wherein said casing is made from a metal material.

12. The electronic instrument according to claim 10, wherein said casing is formed with an electroplating layer on said outer surface thereof.

13. The electronic instrument according to claim 10, wherein said shelter member is made from non-metal materials, which include plastic or paper.

14. The electronic instrument according to claim 10, wherein said antenna has a plate configuration, and includes a printed circuit board.

15. The electronic instrument according to claim 10, wherein said antenna has a plate configuration, and is a patch antenna.

16. The electronic instrument according to claim 10, wherein said antenna has a plate configuration, and includes a FPC (flexible printed circuit) or a ceramic antenna.

17. The electronic instrument according to claim 10, wherein said bottom wall portion of said recess in said casing has a depth ranging from 2 mm to 4 mm measured with respect to said outer surface of said casing.

18. An electronic instrument comprising:
a metal casing formed with a recess defining an opening for access to said recess;
an antenna disposed in said recess for transmitting and receiving signals via said opening; and
a shelter member disposed on said casing in such a manner to cover said opening of said recess.

19. The electronic instrument according to claim 18, wherein said shelter member is provided with a logo on an outer face thereof.

20. The electronic instrument according to claim 18, wherein said shelter member is made from a non-conductive material.

21. The electronic instrument according to claim 18, wherein said antenna has a plate configuration, and includes a printed circuit board, a patch antenna, a FPC (flexible printed circuit) or a ceramic antenna.
